(19) United States
(12) Patent Application Publication
(10) Pub. No.: US 2024/0264353 A1
(43) Pub. Date: Aug. 8, 2024

(54) Display Devices Having Gratings With Gradient Edges

(71) Applicant: Apple Inc., Cupertino, CA (US)

(72) Inventor: Brandon Born, Sunnyvale, CA (US)

(21) Appl. No.: 18/414,126

(22) Filed: Jan. 16, 2024

Related U.S. Application Data
(60) Provisional application No. 63/483,152, filed on Feb. 3, 2023.

(51) Int. Cl. F21V 8/00

(52) U.S. Cl. CPC G02B 6/0016; G02B 6/0038

(57) ABSTRACT

A display may include a waveguide and an optical coupler. The coupler may include one or more surface relief gratings (SRGs) in a substrate on the waveguide. The SRG(s) may have a central region and gradient lateral edges separating the central region from a non-diffractive region of the substrate. The SRG(s) may exhibit peak diffraction efficiency within the central region and may exhibit gradient diffraction efficiency across the gradient lateral edges from the central region to the non-diffractive region. The gradient diffraction efficiency may be produced by varying, across the gradient lateral edges, the amplitude of the SRG(s), the phase of the SRG(s), the duty cycle of the SRG(s), the blaze angle of the SRG(s), and/or the thickness of a high or low index coating layered over the SRG(s). This may serve to prevent the couplers from becoming undesirably visible and to minimize perturbation of replicated pupils.

This application claims the benefit of U.S. Provisional Patent Application No. 63/483,152, filed Feb. 3, 2023, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays. If care is not taken, components used to display images can be bulky and might not exhibit desired levels of optical performance. For example, boundaries between the optical elements can cause unsightly cosmetic artifacts.

### SUMMARY

An electronic device may have a display system for providing image light to an eye box. The display system may include a waveguide. An input coupler may couple light into the waveguide. A cross-coupler may perform pupil expansion on the light. An output coupler may couple the light out of the waveguide and towards an eye box. Alternatively, the cross-coupler and the output coupler may be replaced by an interleaved coupler that couples the light out of the waveguide and expands the light.

Any of the couplers may include one or more surface relief gratings (SRGs) in a substrate on the waveguide. The SRG(s) may have a central region and gradient lateral edges that separate the central region from a non-diffractive region of the substrate. The SRG(s) may exhibit peak diffraction efficiency within the central region. The SRG(s) may exhibit a gradient diffraction efficiency across the gradient lateral edges from the central region to the non-diffractive region. The gradient diffraction efficiency may be produced by varying, across the gradient lateral edges, the amplitude of the SRG(s), the phase of the SRG(s), the duty cycle of the SRG(s), the blaze angle of the SRG(s), and/or the thickness of a high or low index coating layered over the SRG(s).

The gradient lateral edges may serve to prevent sharp boundaries between the couplers and the non-diffractive region of the substrate. This may prevent the couplers from becoming undesirably visible, noticeable, and/or distracting to a user of the system and/or to other persons facing the user. This may also serve to minimize perturbation of replicated pupils, thereby improving modulation transfer function (MTF) and mitigating cosmetic image artifacts such as smear and double images.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIGS. 3A-3C are top views of illustrative waveguides provided with a surface relief grating in accordance with some embodiments.

FIG. 4 is a front view of an illustrative waveguide having optical couplers formed from surface relief gratings in accordance with some embodiments.

FIG. 5 is a front view of an illustrative waveguide having an optical coupler with first and second overlapping surface relief gratings oriented in different directions in accordance with some embodiments.

FIG. 6 is a front view of an illustrative optical coupler having one or more surface relief gratings with gradient lateral edges in accordance with some embodiments.

FIG. 7 is a cross-sectional top view of an illustrative surface relief grating having gradient lateral edges formed by varying the thickness of a coating on the surface relief grating in accordance with some embodiments.

FIG. 8 is a cross-sectional top view of an illustrative surface relief grating having gradient lateral edges formed by varying grating depth in accordance with some embodiments.

FIG. 9 is a cross-sectional top view of an illustrative surface relief grating having gradient lateral edges formed by varying duty cycle in accordance with some embodiments.

### DETAILED DESCRIPTION

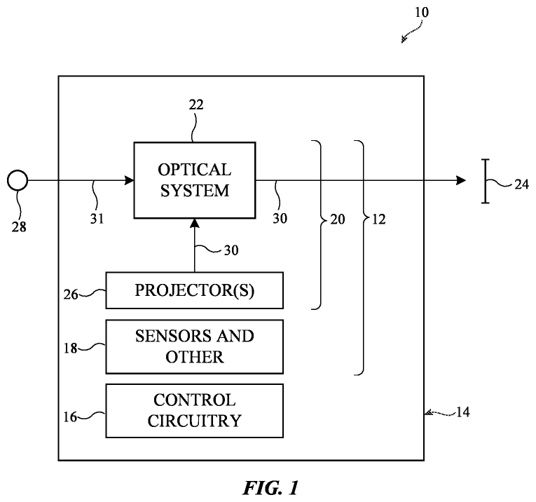

System 10 of FIG. 1 maybe a head-mounted device having one or more displays. The displays in system 10 mayinclude near-eye displays 20 mounted within support structure (housing) 14. Support structure 14 mayhave the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 mayinclude one or more display projectors such as projectors 26 (sometimes referred to herein as display modules 26) and one or more optical systems such as optical systems 22. Projectors 26 maybe mounted in a support structure such as support structure 14. Each projector 26 mayemit image light 30 that is redirected towards a user's eyes at eye box 24 using an associated one of optical systems 22. Image light 30 maybe, for example, light that contains and/or represents something viewable such as a scene or object (e.g., as modulated onto the image light using the image data provided by the control circuitry to the display module).

The operation of system 10 maybe controlled using control circuitry 16. Control circuitry 16 mayinclude storage and processing circuitry for controlling the operation of system 10. Circuitry 16 mayinclude storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 maybe based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 maybe used to allow data to be received by system 10 from external equipment (e.g., a tethered computer, a portable device such as a handheld device or laptop computer, or other electrical equipment) and to allow a user to provide head-mounted device 10 with user input. Input-output devices 12 mayalso be used to gather information on the environment in which system 10 (e.g., head-mounted device 10) is operating. Output components in devices 12 mayallow system 10 to provide a user with output and may be used to communicate with external electrical equipment. Input-output devices 12 mayinclude sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 mayinclude liquid crystal displays, organic light-emitting diode displays, laser-based displays, or displays of other types. Projectors 26 mayinclude light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 mayform lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 mayproduce images for both eyes or a pair of displays 20 maybe used to display images. In configurations with multiple displays (e.g., left and right eye displays), the focal length and positions of the lenses formed by system 22 maybe selected so that any gap present between the displays will not be visible to a user (e.g., so that the images of the left and right displays overlap or merge seamlessly).

If desired, optical system 22 maycontain components (e.g., an optical combiner, etc.) to allow real-world light 31 (sometimes referred to herein as world light 31 or ambient light 31) produced and/or reflected from real-world objects 28 (sometimes referred to herein as external objects 28) to be combined optically with virtual (computer-generated) images such as virtual images in image light 30. In this type of system, which is sometimes referred to as an augmented reality system, a user of system 10 mayview both real-world content and computer-generated content that is overlaid on top of the real-world content. Camera-based augmented reality systems may also be used in device 10 (e.g., in an arrangement in which a camera captures real-world images of external objects and this content is digitally merged with virtual content at optical system 22).

System 10 may if desired, include wireless circuitry and/or other circuitry to support communications with a computer or other external equipment (e.g., a computer that supplies display 20 with image content). During operation, control circuitry 16 maysupply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

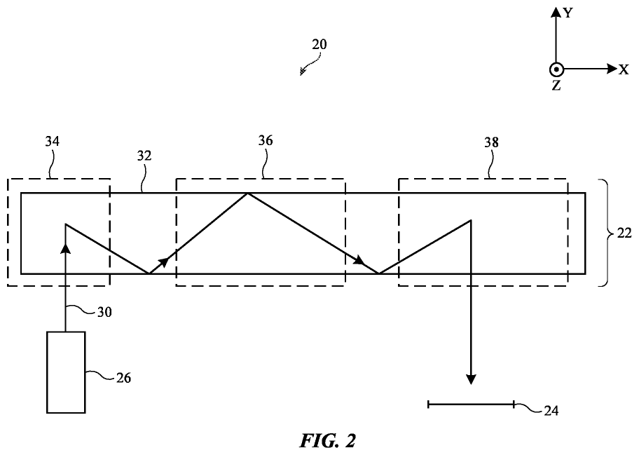

FIG. 2 is a top view of an illustrative display 20 that may be used in system 10 of FIG. 1. As shown in FIG. 2, display 20 mayinclude a projector such as projector 26 and an optical system such as optical system 22. Optical system 22 mayinclude optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer), gratings formed from patterns of metal structures, etc. The diffractive gratings may for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 maygenerate (e.g., produce and emit) image light 30 associated with image content to be displayed to eye box 24 (e.g., image light 30 mayconvey a series of image frames for display at eye box 24). Image light 30 maybe collimated using a collimating lens in projector 26 if desired. Optical system 22 maybe used to present image light 30 output from projector 26 to eye box 24. If desired, projector 26 maybe mounted within support structure 14 of FIG. 1 while optical system 22 maybe mounted between portions of support structure 14 (e.g., to form a lens that aligns with eye box 24). Other mounting arrangements may be used, if desired.

Optical system 22 mayinclude one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection.

Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 mayemit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 mayinclude multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 mayinclude a single optical coupler that performs the operations of both cross-coupler 36 and output coupler 38 (sometimes referred to herein as an interleaved coupler, a diamond coupler, or a diamond expander) or cross-coupler 36 may be separate from output coupler 38. Implementations in which cross-coupler 36 or a single optical coupler that performs the operations of both cross-coupler 36 and output coupler 38 (e.g., which receives light from an input coupler) include surface relief gratings (SRGs) are described herein as an example.

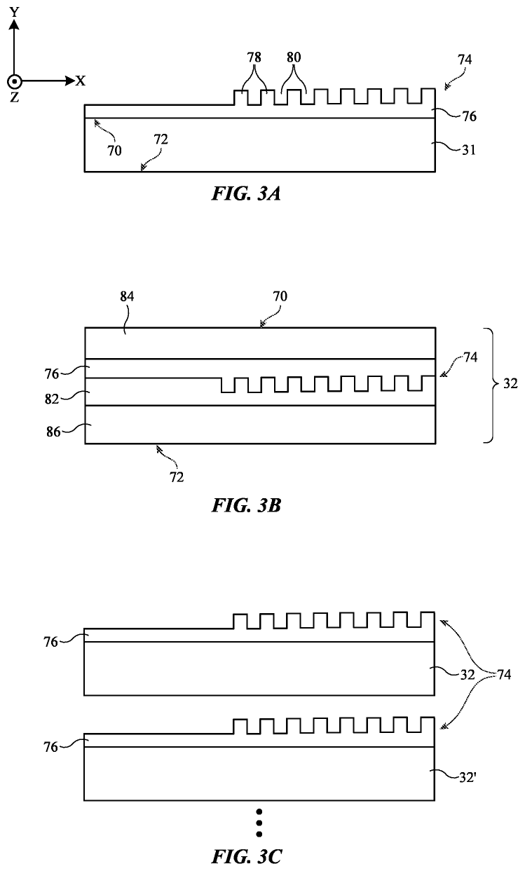

FIG. 3A is a top view showing one example of how a surface relief grating may be formed on waveguide 32. As shown in FIG. 3A, waveguide 32 may have a first lateral surface 70 and a second lateral surface 72 opposite lateral surface 70 (sometimes referred to herein as waveguide surfaces). Waveguide 32 may include any desired number of one or more stacked waveguide substrates. If desired, waveguide 32 may also include a layer of grating medium sandwiched (interposed) between first and second waveguide substrates (e.g., where the first waveguide substrate includes lateral surface 70 and the second waveguide substrate includes lateral surface 72).

Waveguide 32 may be provided with a surface relief grating (SRG) such as surface relief grating 74. SRG 74 may be included in cross-coupler 36 or as part of an optical coupler that performs the operations of both cross-coupler 36 and output coupler 38 (e.g., a diamond expander or interleaved coupler), for example. SRG 74 may be formed within a substrate such as a layer of SRG substrate 76 (sometimes referred to herein as medium 76, medium layer 76, SRG medium 76, or SRG medium layer 76). While only a single SRG 74 is shown in SRG substrate 76 in FIG. 3A for the sake of clarity, SRG substrate 76 may include two or more SRGs 74 (e.g., SRGs having different respective grating vectors). If desired, at least a portion of each of the SRGs may be superimposed in the same volume of SRG substrate 76. In the example of FIG. 3A, SRG substrate 76 is layered onto lateral surface 70 of waveguide 32. This is merely illustrative and, if desired, SRG substrate 76 may be layered onto lateral surface 72 (e.g., the surface of waveguide 32 that faces the eye box).

SRG 74 may include peaks 78 and troughs 80 in the thickness of SRG substrate 76. Peaks 78 may sometimes also be referred to herein as ridges 78 or maxima 78. Troughs 80 may sometimes also be referred to herein as notches 80, slots 80, grooves 80, or minima 80. In the example of FIG. 3A, SRG 74 is illustrated for the sake of clarity as a binary structure in which SRG 74 is defined either by a first thickness associated with ridges 78 or a second thickness associated with troughs 80. This is merely illustrative. If desired, SRG 74 may be non-binary (e.g., may include any desired number of thicknesses following any desired profile, may include ridges 78 that are angled at non-parallel fringe angles with respect to the Y axis, etc.)., may include ridges 78 with surfaces that are tilted (e.g., oriented outside of the X-Z plane), may include troughs 80 that are tilted (e.g., oriented outside of the X-Z plane), may include ridges 78 and/or troughs 80 that have heights and/or depths that follow a modulation envelope, etc. If desired, SRG substrate 76 may be adhered to lateral surface 70 of waveguide 32 using a layer of optically clear adhesive (not shown). SRG 74 may be fabricated separately from waveguide 32 and may be adhered to waveguide 32 after fabrication or may be etched into SRG substrate 76 after SRG substrate 76 has already been layered on waveguide 32, for example.

The example of FIG. 3A is merely illustrative. In another implementation, SRG 74 may be placed at a location within the interior of waveguide 32, as shown in the example of FIG. 3B. As shown in FIG. 3B, waveguide 32 may include a first waveguide substrate 84, a second waveguide substrate 86, and a media layer 82 interposed between waveguide substrate 84 and waveguide substrate 86. Media layer 82 may be a grating or holographic recording medium, a layer of adhesive, a polymer layer, a layer of waveguide substrate, or any other desired layer within waveguide 32. SRG substrate 76 may be layered onto the surface of waveguide substrate 84 that faces waveguide substrate 86. Alternatively, SRG substrate 76 may be layered onto the surface of waveguide substrate 86 that faces waveguide substrate 84.

If desired, multiple SRGs 74 may be distributed across multiple layers of SRG substrate, as shown in the example of FIG. 3C. As shown in FIG. 3C, the optical system may include multiple stacked waveguides such as at least a first waveguide 32 and a second waveguide 32′. A first SRG substrate 76 may be layered onto one of the lateral surfaces of waveguide 32 whereas a second SRG substrate 76′ is layered onto one of the lateral surfaces of waveguide 32′. First SRG substrate 76 may include one or more of the SRGs 74. Second SRG substrate 76′ may include one or more of the SRGs 74. This example is merely illustrative. If desired, the optical system may include more than two stacked waveguides. In examples where the optical system includes more than two waveguides, each waveguide that is provided with an SRG substrate may include one or more SRG 74. While described herein as separate waveguides, waveguides 32 and 32′ of FIG. 3C may also be formed from respective waveguide substrates of the same waveguide, if desired. The arrangements in FIGS. 3A, 3B, and/or 3C may be combined if desired.

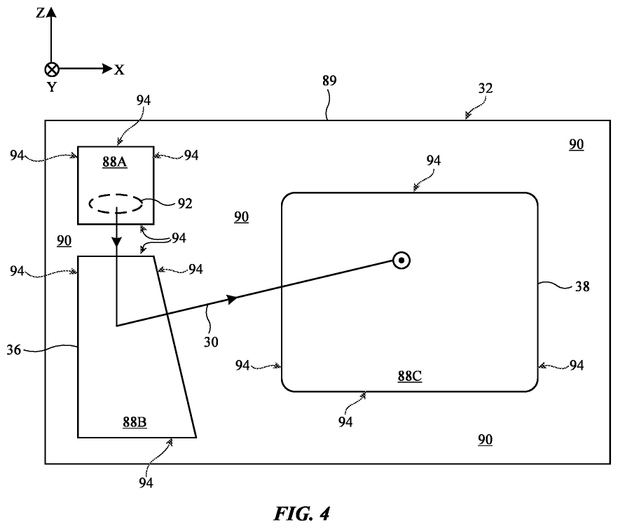

If desired, waveguide 32 may include one or more substrates having regions that include diffractive gratings for input coupler 34, cross-coupler 36, and/or output coupler 38 and having regions that are free from diffractive gratings. FIG. 4 is a front view showing one example of how waveguide 32 may include one or more substrates having regions that include diffractive gratings for input coupler 34, cross-coupler 36, and/or output coupler 38 and having regions that are free from diffractive gratings.

As shown in FIG. 4, waveguide 32 may include one or more substrates 89 (e.g., a single substrate 89 or multiple stacked substrates 89) on one or more waveguides 32 (e.g., a single waveguide 32 or multiple stacked waveguides 32). Substrate(s) 89 may include one or more layers of grating media such as SRG substrate 76 (FIGS. 3A-3B). One or more diffractive grating structures 88 used to form optical couplers for waveguide 32 may be disposed or formed in substrate(s) 89. Each diffractive grating structure 88 may include one or more SRGs 74 (FIGS. 3A-3C).

For example, substrate(s) 89 may include a first diffractive grating structure 88A (sometimes referred to herein as grating structure 88A or grating(s) 88A) formed from a first set of one or more overlapping SRGs 74 (FIGS. 3A-3C) in a first region of substrate(s) 89. If desired, substrate(s) 89 may also include a second diffractive grating structure 88B (sometimes referred to herein as grating structure 88B or grating(s) 88B) formed from a second set of one or more overlapping SRGs 74 in a second region of substrate(s) 89 that is laterally separated from first diffractive grating structure 88A. If desired, substrate(s) 89 may further include a third diffractive grating structure 88C (sometimes referred to herein as grating structure 88C or grating(s) 88C) formed from a third set of one or more overlapping SRGs 74 in a third region of substrate(s) 89 that is laterally separated from first diffractive grating structure 88A and second diffractive grating structure 88B.

Diffractive grating structures 88A, 88B, and 88C may each form respective optical couplers for waveguide 32. For example, diffractive grating structure 88A may form input coupler 34 for waveguide 32. Diffractive grating structure 88B may form cross-coupler (e.g., pupil expander) 36 on waveguide 32. Diffractive grating structure 88C may form output coupler 38 for waveguide 32. Diffractive grating structure 88A may therefore couple a beam 92 of image light 30 into waveguide 32 and towards diffractive grating structure 88B. Diffractive grating structure 88B may redirect image light 30 towards diffractive grating structure 88C and mayoptionally perform pupil expansion on image light 30 (e.g., may split image light 30 into multiple paths to form a larger beam that covers the eye pupil and forms a more uniform image). Diffractive grating structure 88C may couple image light 30 out of waveguide 32 and towards the eye box. If desired, diffractive grating structure 88C may also perform pupil expansion on image light 30.

Substrate(s) 89 and thus waveguide 32 may also include one or more regions 90 that are free from diffractive grating structures 88, diffractive gratings, or optical couplers. Regions 90 may for example, be free from ridges 78 and troughs 80 of any SRGs (FIGS. 3A-3C) and may if desired, be free from refractive index modulations of VPHs. Regions 90 may separate diffractive grating structure 88A from diffractive grating structure 88B, may separate diffractive grating structure 88B from diffractive grating structure 88C, may separate diffractive grating structure 88C from diffractive grating structure 88A, and/or may laterally surround one or all of diffractive grating structures 88A-C. Regions 90 may sometimes be referred to herein as grating-free regions 90, inter-grating regions 90, non-grating regions 90, or non-diffractive regions 90. Non-diffractive regions 90 may for example, include all of the lateral area of substrate(s) 89 that does not include a diffractive grating.

Each diffractive grating structure 88 in substrate(s) 89 may span a corresponding lateral area of substrate(s) 89. The lateral area spanned by each diffractive grating structure 88 is defined (bounded) by the lateral edge(s) 94 of that diffractive grating structure 88. Lateral edges 94 may separate or divide the portions of substrate(s) 89 that include thickness modulations used to form one or more SRG(s) in diffractive grating structures 88 from the non-diffractive regions 90 on substrate(s) 89. In other words, lateral edges 94 may define the boundaries between diffractive grating structures 88 and non-diffractive regions 90. Diffractive grating structures 88A, 88B, and 88C may have any desired lateral shapes (e.g., as defined by lateral edges 94).

The example of FIG. 4 is merely illustrative and, in general, input coupler 34, cross-coupler 36, and output coupler 38 may have any desired lateral outlines or shapes (e.g., as defined by lateral edges 94). If desired, waveguide 32 may include an optical coupler that both redirects and expands/replicates image light 30 (e.g., for filling as large of an eye box 24 with as uniform-intensity image light 30 as possible). Such an optical coupler, which is sometimes referred to herein as a diamond expander or interleaved coupler, may perform the functionality of both cross coupler 36 and output coupler 38. By using the optical coupler as both a cross-coupler and an output coupler, space may be conserved within the display (e.g., space that would otherwise be occupied by separate cross-coupler and output couplers).

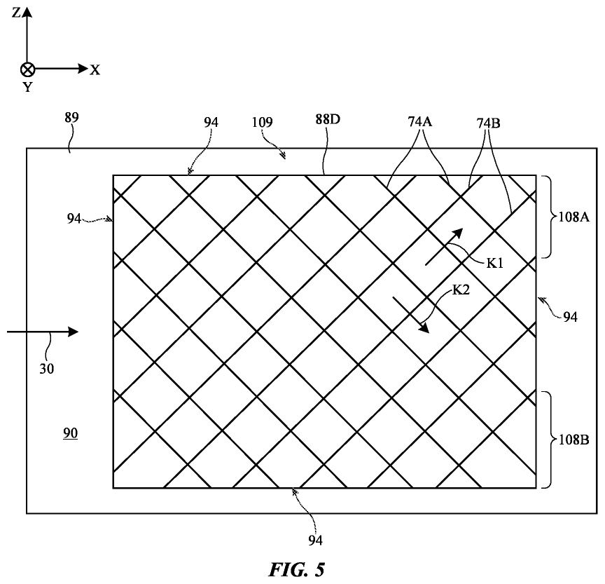

FIG. 5 is a front view of one such optical coupler 109 on waveguide 32. Optical coupler 109 may for example, replace cross coupler 36 and output coupler 38 on waveguide 32 of FIG. 4. As shown in FIG. 5, optical coupler 109 may include a diffractive grating structure 88D having at least a first SRG 74A and a second SRG 74B on substrate(s) 89 (e.g., superimposed with each other in the same volume of a single substrate 89). Each of SRGs 74A and 74B may include a respective set of ridges 78 and troughs 80 (FIGS. 3A-3C) in substrate 89 and extending in different respective orientations. For example, SRG 74A may be characterized by a first grating vector K1 (e.g., oriented orthogonal to the direction of the peaks, troughs, or lines of constant medium thickness in SRG 74A). Similarly, SRG 74B may be characterized by a second grating vector K2 (e.g., oriented orthogonal to the direction of the peaks, troughs, or lines of constant medium thickness in SRG 74B). Grating vector K2 may be oriented non-parallel with respect to grating vector K1.

The magnitude of grating vector K1 corresponds to the widths and spacings (e.g., the period) of the ridges 78 and troughs 80 (fringes) in SRG 74A, as well as to the wavelengths of light diffracted by the SRG. The magnitude of grating vector K2 corresponds to the widths and spacings (e.g., the period) of the ridges 78 and troughs 80 in SRG 74B, as well as to the wavelengths of light diffracted by the SRG. Surface relief gratings generally have a wide bandwidth. The bandwidth of SRGs 74A and 74B may encompass each of the wavelengths in image light 30, for example (e.g., the entire visible spectrum, a portion of the visible spectrum, portions of the infrared or near-infrared spectrum, some or all of the visible spectrum and a portion of the infrared or near-infrared spectrum, etc.).The magnitude of grating vector K2 may be equal to the magnitude of grating vector K1 or may be different from the magnitude of grating vector K1. While illustrated within the plane of the page of FIG. 5 for the sake of clarity, grating vectors K1 and/or K2 may have non-zero vector components parallel to the Y-axis (e.g., grating vectors K1 and K2 may be tilted into or out of the page).

SRG 74A at least partially overlaps SRG 74B in optical coupler 109 (e.g., at least some of the ridges and troughs of each SRG spatially overlap or are superimposed within the same volume of SRG substrate). If desired, the strength of SRG 74A and/or SRG 74B may be modulated in the vertical direction (e.g., along the Z-axis) and/or in the horizontal direction (e.g., along the X-axis). If desired, one or both of SRGs 74A and 74B may have a magnitude that decreases to zero within peripheral regions 108A and 108B of the field of view, which may help to mitigate the production of rainbow artifacts.

Image light 30 maybe conveyed to optical coupler 89 through waveguide 32 (e.g., via total internal reflection). SRGs 74A and 74B may diffract incident image light 30 in two different directions, thereby replicating pupils of the image light. SRGs 74A and 74B may additionally or alternatively expand pupils of the image light. This creates multiple optical paths for image light 30 within optical coupler 89 and allows as large an eye box as possible to be filled with image light 30 of uniform intensity.

As shown in FIG. 5, diffractive grating structure 88D may span a corresponding lateral area of substrate(s) 89. The lateral area spanned by diffractive grating structure 88D is defined (bounded) by the lateral edge(s) 94 of diffractive grating structure 88D. Lateral edges 94 may separate or divide the portions of substrate(s) 89 that include thickness modulations used to form one or more SRG(s) in diffractive grating structures 88D from the non-diffractive regions 90 on substrate(s) 89. In other words, lateral edges 94 may define the boundaries between diffractive grating structures 88D and non-diffractive regions 90. Diffractive grating structures 88D may have any desired lateral shape (e.g., as defined by lateral edges 94).

While optical couplers on waveguide 32 (e.g., optical couplers 34, 36, or 38 of FIG. 4 or optical coupler 109 of FIG. 5) redirect image light 30 for display at eye box 24, the diffractive grating structure 88 (e.g., diffractive grating structures 88A-C of FIG. 4 or diffractive grating structure 88D of FIG. 5) in each optical coupler may also incidentally diffract ambient light from the environment (e.g., world light 31 of FIG. 1) in different directions. In some implementations, lateral edges 94 are sharp, precisely-defined, boundaries between the SRGs of the diffractive grating structure 88 in the optical coupler and non-diffractive regions 90 of substrate(s) 89. In these implementations, the diffractive strength (e.g., diffraction efficiency) of substrate(s) 89 varies sharply at lateral edges 94, from a peak strength within diffractive grating structure 88 to a strength of zero in non-diffractive regions 90. As such, the amount of ambient light diffracted by the SRG(s) in diffractive grating structure 88 varies sharply from a peak amount to zero on either side of lateral edges 94. The sharp boundary may cause diffractive grating structure 88 and the corresponding optical coupler to become undesirably visible, noticeable, and/or distracting to the user of system 10 and/or to other persons facing system 10 while system 10 is being worn by the user (e.g., as a rainbow-colored region or cosmetic artifact on waveguide 32 that is surrounded by transparent non-diffractive regions 90, which do not diffract the ambient light). The boundary may also undesirably perturb pupil replication by the diffractive grating structure, which can produce undesirable cosmetic artifacts such as smear or double images.

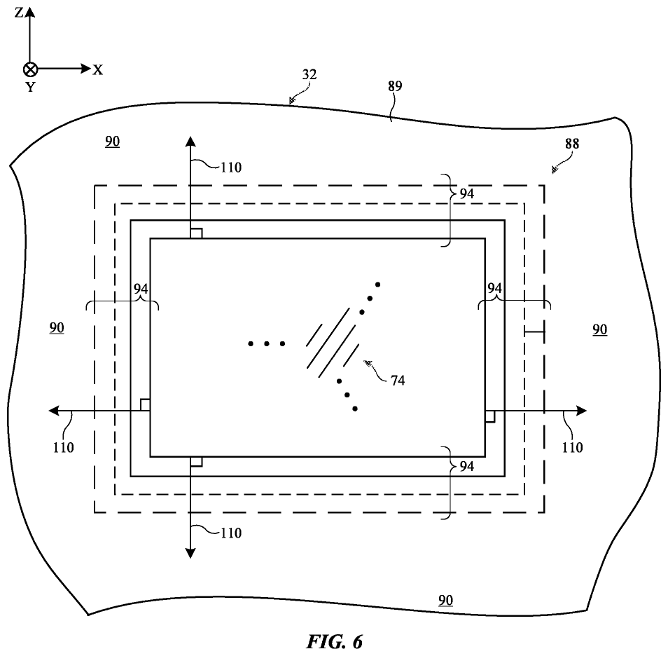

To mitigate these issues, diffractive grating structure 88 may be provided with one or more gradient lateral edges 94 (sometimes referred to herein as blurred lateral edges 94, transitional lateral edges 94, diffused lateral edges 94, fuzzed lateral edges 94, or unsharp lateral edges 94). FIG. 6 is a front view of waveguide 32 having an exemplary diffractive grating structure 88 with gradient lateral edges 94. As shown in FIG. 6, diffractive grating structure 88 (e.g., diffractive grating structure 88A for input coupler 34 of FIG. 4, diffractive grating structure 88B for cross-coupler 36 of FIG. 4, diffractive grating structure 88C for output coupler 38 of FIG. 4, and/or diffractive grating structure 88D for optical coupler 109 of FIG. 5) may include one or more SRGs 74 in substrate(s) 89 on waveguide 32.

Diffractive grating structure 88 may be laterally bounded on substrate(s) 89 (e.g., within the X-Z plane) by gradient lateral edges 94. In the example of FIG. 6, all of the lateral edges of diffractive grating structure 88 are gradient lateral edges. This is merely illustrative and, if desired, gradient lateral edges may be sued to form some but not all of the lateral edges of diffractive grating structure 88. Gradient lateral edges 94 may be formed by gradually decreasing the strength of the SRG(s) 74 (and thus the diffraction efficiency of the SRGs) in diffractive grating structure 88 from a peak strength (peak diffraction efficiency) within gradient lateral edges 94 to a strength (diffraction efficiency) of zero at non-diffractive regions 90 on substrate(s) 89. The direction or gradient of the decrease in strength may be oriented orthogonal to the direction of gradient lateral edges 94 (within the X-Z plane), as shown by arrows 110.

In other words, rather than being one-dimensional lines, gradient lateral edges 94 may instead be formed from two-dimensional (peripheral) regions or areas of substrate(s) 89 laterally surrounding a central region 136 of diffractive grating structure 88 and extending from central region 136 to non-diffractive regions 90 in the direction of arrows 110. At gradient lateral edges 94, the strength (diffraction efficiency) of the SRG(s) in diffractive grating structure 88 may decrease in the direction of arrows 110 from the strength of the SRG(s) in central region 136 to a strength of zero in non-diffractive regions 90 (e.g., in a radial outward direction from central region 136). At gradient lateral edges 94, the strength of the SRG(s) in diffractive grating structure 88 may be configured to decrease in the direction of arrows 110 by varying, in the direction of arrows 110 and across gradient lateral edges 94, the amplitude of the SRG(s) (e.g., the height of ridges 78 of FIGS. 3A-3C and/or the depth of troughs 80 of FIGS. 3A-3C), the phase of the SRG(s), the duty cycle of the SRG(s), the blaze angle of the SRG(s), the thickness of a coating layered over the SRG(s), and/or any other desired properties of the SRG(s).

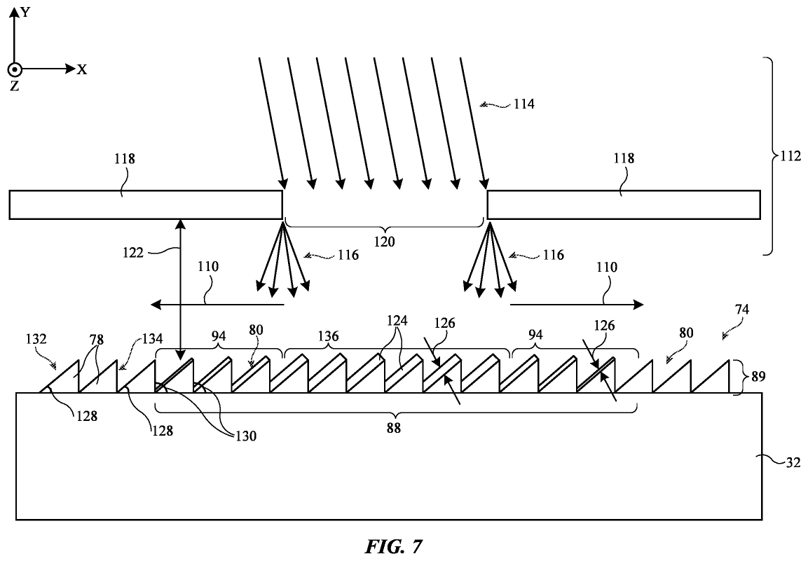

FIG. 7 is a cross-sectional top view showing one example of how the gradient lateral edges 94 of diffractive grating structure 88 may be formed by varying the thickness of a coating on the SRG(s) in diffractive grating structure 88 in the direction of arrows 110. As shown in FIG. 7, diffractive grating structure 88 may include at least one SRG 74 formed in substrate 89 on waveguide 32. Waveguide 32 may be formed from a high-index material such as glass. The index of refraction of waveguide 32 may be greater than 1.5, greater than 1.7, greater than 1.8, greater than 1.9, greater than 2.0, greater than 2.2, greater than 2.4, greater than 2.5, between 1.9 and 2.1, etc. SRG 74 may include ridges 78 that are formed from a high-index material. The material used for ridges 78 may be silicon nitride, titanium dioxide or another desired high-index material, as examples. The index of refraction of ridges 78 may be greater than 1.5, greater than 1.8, greater than 2.0, greater than 2.2, greater than 2.4, greater than 2.5, etc.

In the example of FIG. 7, SRG 74 is a blazed grating having ridges 78 with non-parallel sidewalls. This is merely illustrative and, if desired, one or more (e.g., all) of ridges 78 may have parallel sidewalls or may be approximately parallel (e.g., within 5 degrees, within 3 degrees, within 1 degree, etc.). For the blazed grating of FIG. 7, each ridge 78 is defined by a first surface 132 and an opposing second surface 134.

The surface 132 of each ridge 78 may be oriented at an angle 128 relative to the upper lateral surface of waveguide 32 (or to the bottom surface of substrate 89). Angle 128 (sometimes referred to as the blaze angle) may have any desired magnitude (e.g., between 10 degrees and 40 degrees, between 15 degrees and 40 degrees, between 25 degrees and 35 degrees, between 25 degrees and 30 degrees, greater than 10 degrees, greater than 20 degrees, greater than 30 degrees, greater than 40 degrees, less than 10 degrees, less than 20 degrees, less than 30 degrees, less than 40 degrees, etc.).

The surface 134 of each ridge 78 may be oriented at an angle 130 relative to the upper lateral surface of waveguide 32 (or to the bottom surface of substrate 89). Angle 130 (sometimes referred to as the anti-blaze angle) may have any desired magnitude (e.g., greater than 75 degrees, greater than 85 degrees, greater than 90 degrees, greater than 100 degrees, greater than 110 degrees, between 85 degrees and 110 degrees, less than 90 degrees, less than 110 degrees, etc.).

Each trough 80 may have an open angle given by the difference between angle 130 and angle 128. The open angle may be between 60 degrees and 120 degrees, between 70 degrees and 110 degrees, between 80 degrees and 100 degrees, between 75 degrees and 85 degrees, between 85 degrees and 95 degrees, greater than 60 degrees, greater than 70 degrees, greater than 80 degrees, greater than 90 degrees, greater than 100 degrees, greater than 110 degrees, less than 60 degrees, less than 70 degrees, less than 80 degrees, less than 90 degrees, less than 100 degrees, less than 110 degrees, etc.

Each ridge 78 may have a height measured parallel to the Y-axis from waveguide 32 to the maximum thickness of the ridge. The height of ridges 78 may be greater than 50 nanometers, greater than 100 nanometers, greater than 200 nanometers, greater than 300 nanometers, greater than 500 nanometers, less than 50 nanometers, less than 100 nanometers, less than 200 nanometers, less than 300 nanometers, less than 500 nanometers, between 50 nanometers and 300 nanometers, etc. Each ridge 78 may also have a width measured parallel to the X-axis across its base at waveguide 32. The width of ridges 78 may be greater than 50 nanometers, greater than 100 nanometers, greater than 200 nanometers, greater than 300 nanometers, greater than 500 nanometers, less than 50 nanometers, less than 100 nanometers, less than 200 nanometers, less than 300 nanometers, less than 500 nanometers, between 50 nanometers and 300 nanometers, between 300 nanometers and 400 nanometers, etc.

A coating 124 may be deposited over the ridges 78 in diffractive grating structure 88. If desired, coating 124 may be directionally deposited over surfaces 132 but not surfaces 134 of ridges 78. Coating 124 may be a high-index coating (e.g., having a refractive index greater than that of substrate 89 and/or waveguide 32 by greater than 0.1, greater than 0.3, greater than 0.5, greater than 0.7, greater than 1.0, etc.) or a low-index coating (e.g., having a refractive index less than that of substrate 89 and/or waveguide 32 by greater than 0.1, greater than 0.2, greater than 0.5, greater than 0.7, greater than 1.0, etc.). Coating 124 may include titanium dioxide (TiO₂) or silicon dioxide (SiO₂), as two examples. If desired, an encapsulation layer (not shown) may be deposited over the coated ridges 78. Coating 124 may help to boost the contrast between waveguide 32 and the material above substrate 89 (e.g., air or an encapsulation layer) to help maximize the diffraction efficiency of the grating and/or may help to mitigate undesired reflections. If desired, a residual or sacrificial substrate (not shown) may be interposed between substrate 89 and waveguide 32. The residual substrate may be formed from the same material as ridges 78 and may be left over from a nanoimprinting process in which ridges 78 are formed.

As shown in FIG. 7, coating 124 may have a corresponding thickness 126 on ridges 78. Coating 124 may exhibit a peak thickness within central region 136 of diffractive grating structure 88. Coating 124 may exhibit a variable thickness within the gradient lateral edges 94 of diffractive grating structure 88. For example, the thickness of coating 124 may decrease across gradient lateral edges 94 in the direction of arrows 110 from a maximum thickness in central region 136 to a thickness of zero outside of gradient lateral edges 94. Decreasing the coating thickness across gradient lateral edges 94 in this way may serve to reduce the strength and diffraction efficiency of the SRG(s) 74 in diffractive grating structure 88 across gradient lateral edges 94 (in the direction of arrows 110), preventing a sharp boundary between diffractive grating structure 88 and the surrounding portions of substrate 89.

Manufacturing equipment 112 may be used to form SRG 74 in substrate 89 and to deposit coating 124 onto SRG 74. After SRG 74 has been etched or cut into substrate 89, manufacturing equipment 112 may deposit coating 124 onto SRG 74. Manufacturing equipment 112 may include coating deposition equipment that directionally deposits coating 124 onto the surfaces 132 of SRG 74 through an aperture 120 in mask 118, as shown by arrows 114. The coating material may scatter or diffract at the edges of aperture 120, as shown by arrows 116.

This diffraction may cause coating 124 to be deposited with a decreasing thickness 126 in the direction of arrows 110 within gradient lateral edges 94 of diffractive grating structure 88. At the same time, the portion of the coating material that passes through aperture 120 without diffracting at the edges of aperture 120 is deposited with a peak thickness 126 within central region 136. By adjusting the separation 122 between mask 118 and SRG 74, manufacturing equipment 112 may change the gradient in thickness of coating 124 and thus the width of gradient lateral edges 94. In the example of FIG. 7, substrate 89 includes additional ridges 78 and troughs 80 outside of gradient lateral edges 94 of diffractive grating structure 88. This is merely illustrative and, if desired, substrate 89 may be free from ridges 78 and troughs 80 outside of gradient lateral edges 94 (e.g., to form non-diffractive regions 90). Other deposition equipment or techniques may be used to form coating 124.

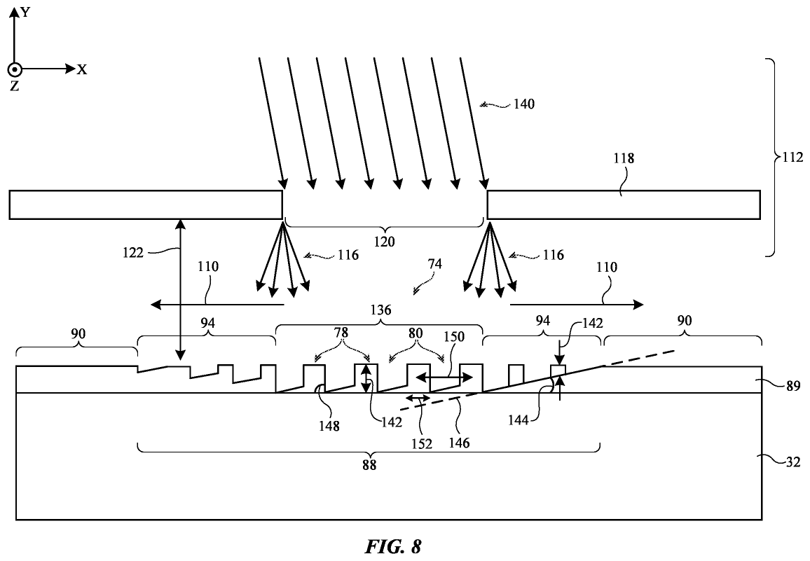

FIG. 8 is a cross-sectional top view showing one example of how the gradient lateral edges 94 of diffractive grating structure 88 may be formed by varying the depth of troughs 80 (sometimes referred to herein as the grating depth) in the SRG(s) 74 of diffractive grating structure 88 (or equivalently varying the height of ridges 78 relative to the bottom of troughs 80).

In the example of FIG. 8, ridges 78 have parallel sidewalls that are oriented at a non-perpendicular angle with respect to the lateral surface of waveguide 32. This is merely illustrative and, in general, the sidewalls may be at any desire orientations, SRG 74 may be a blazed grating, etc.

In FIG. 8, substrate 89 has a planar upper surface opposite waveguide 32. Each ridge 78 has an upper surface that is separated from waveguide 32 (or an underlying residual substrate that is not shown) by the same distance across diffractive grating structure 88. Each trough 80 may have a corresponding depth 142 (sometimes referred to herein as the height 142 or thickness 142 of troughs 80). Troughs 80 may have a first depth (e.g., a maximum depth) 142 within central region 136 of diffractive grating structure 88. Troughs 80 may have a variable depth 142 within the gradient lateral edges 94 of diffractive grating structure 88. The depth 142 of troughs 80 may decrease across gradient lateral edges 94 in the direction of arrows 110 from the first depth 142 in central region 136 to a depth of zero outside of gradient lateral edges 94 (e.g., within non-diffractive regions 90).

In general, the decrease in trough depth may follow any desired function 146 (in the direction of arrows 110) that decreases from central region 136 to non-diffractive regions 90 across gradient lateral edges 94. For example, as shown in FIG. 8, the depth modulation of the ridges in SRG 74 (e.g., function 146) may be characterized by line or plane having an angle of inclination 144. This angle characterizes how the depth of troughs 80 changes across gradient lateral edges 94. Angle 144 may be less than 10 degrees, less than 1 degree, less than 0.1 degree, less than 0.01 degree, less than 0.001 degree, less than 0.0001 degree, less than 30 degrees, less than 45 degrees, less than 60 degrees, etc. The bottom surface of troughs 80 may be oriented parallel to the lateral surface of waveguide 32 or non-parallel to the lateral surface of waveguide 32. For example, as shown in FIG. 8, the bottom surface of troughs 80 may be oriented parallel to function 146. This is merely illustrative.

The magnitude of the depth 142 of each trough may be greater than 50 nanometers, greater than 100 nanometers, greater than 200 nanometers, greater than 300 nanometers, greater than 500 nanometers, greater than 750 nanometers, greater than 1000 nanometers, less than 50 nanometers, less than 100 nanometers, less than 200 nanometers, less than 300 nanometers, less than 500 nanometers, less than 750 nanometers, less than 1000 nanometers, between 200 nanometers and 400 nanometers, between 100 nanometers and 750 nanometers, between 50 nanometers and 1000 nanometers, etc. Trough depth is generally proportional to diffraction efficiency. Decreasing the grating depth across gradient lateral edges 94 in this way may serve to reduce the strength and diffraction efficiency of the SRG(s) 74 in diffractive grating structure 88 across gradient lateral edges 94 (in the direction of arrows 110), preventing a sharp boundary between diffractive grating structure 88 and the surrounding portions of substrate 89.

Manufacturing equipment 112 may be used to form SRG 74 in substrate 89 (e.g., by etching or cutting troughs 80 in substrate 89). As shown in FIG. 8, manufacturing equipment 112 may include etching elements 140 (e.g., laser light or other optical emitters, lithographic equipment, etc.) that pass through aperture 120 in mask 118. Etching elements 140 may scatter or diffract at the edges of aperture 120, as shown by arrows 116. This diffraction may cause etching elements 140 to form troughs 80 in substrate 89 with a decreasing depth 142 in the direction of arrows 110 within gradient lateral edges 94 of diffractive grating structure 88. At the same time, the portion of etching elements 140 that passes through aperture 120 without diffracting at the edges of aperture 120 forms troughs 80 with a uniform depth within central region 136. By adjusting the separation 122 between mask 118 and substrate 89, manufacturing equipment 112 may change the gradient in the depth of troughs 80 and thus the width of gradient lateral edges 94.

Each ridge 78 in diffractive grating structure 88 may have a corresponding width 152 (sometimes referred to herein as ridge width 152). Width 152 may be greater than 50 nanometers, greater than 100 nanometers, greater than 200 nanometers, greater than 300 nanometers, greater than 500 nanometers, less than 50 nanometers, less than 100 nanometers, less than 200 nanometers, less than 300 nanometers, less than 500 nanometers, between 50 nanometers and 300 nanometers, between 300 nanometers and 400 nanometers, etc.

The center-to-center spacing between the ridges 78 (sometimes referred to herein as pitch 150 or ridge pitch 150) may be any desired magnitude (e.g., greater than 50 nanometers, greater than 100 nanometers, greater than 200 nanometers, greater than 300 nanometers, greater than 500 nanometers, greater than 750 nanometers, greater than 1000 nanometers, less than 50 nanometers, less than 100 nanometers, less than 200 nanometers, less than 300 nanometers, less than 500 nanometers, less than 750 nanometers, less than 1000 nanometers, between 200 nanometers and 400 nanometers, between 300 nanometers and 400 nanometers, between 100 nanometers and 750 nanometers, etc.).

The duty cycle of the ridges (defined as ridge width 152 divided by ridge pitch 150) may be greater than 60%, greater than 70%, greater than 80%, greater than 90%, greater than 95%, less than 99%, less than 70%, less than 80%, less than 90%, less than 95%, between 60% and 99%, etc. In the examples of FIGS. 7 and 8, diffractive grating structure 88 exhibits a uniform duty cycle across its lateral area (e.g., across both central region 136 and gradient lateral edges 94). If desired, the duty cycle of ridges 78 may be varied to form gradient lateral edges 94.

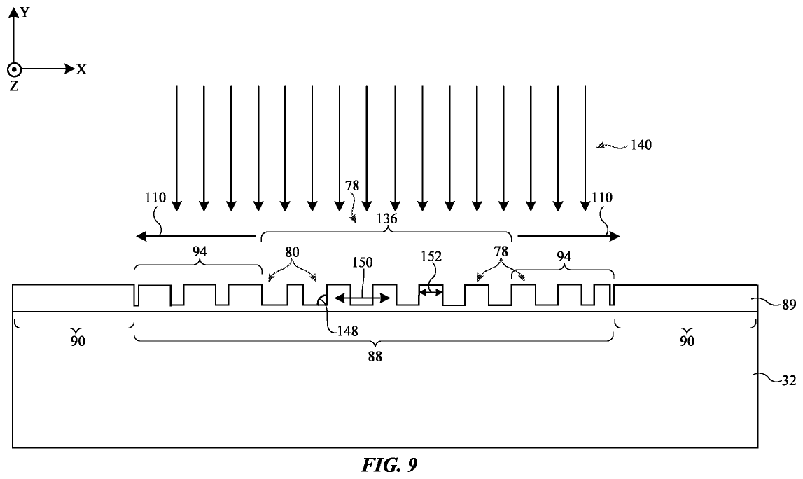

FIG. 9 is a cross-sectional top view showing one example of how the gradient lateral edges 94 of diffractive grating structure 88 may be formed by varying the duty cycle of the

SRG(s) 74 in diffractive grating structure 88. In the example of FIG. 9, ridges 78 have parallel sidewalls that are oriented at a perpendicular angle with respect to the lateral surface of waveguide 32. This is merely illustrative and, in general, the sidewalls may be at any desired orientations, SRG 74 may be a blazed grating, etc.

As shown in FIG. 9, diffractive grating structure 88 may have a first ridge width 152 and a first ridge pitch 150, and thus a first (constant) duty cycle within central region 136. The width 152 of ridges 78 and/or the pitch 150 of ridges 78 may be varied, thereby varying the duty cycle of the SRG(s), within the gradient lateral edges 94 of diffractive grating structure 88. The duty cycle may increase or decrease from the first duty cycle at central region 136 to a second duty cycle at non-diffractive regions 90 in the direction of arrows 110 across gradient lateral edges 74. In other words, ridge width 152 and/or ridge pitch 150 may increase and/or decrease in the direction of arrows 110 across gradient lateral edges 94.

Varying the duty cycle of SRG(s) 74 across gradient lateral edges 94 in this way may serve to reduce the strength and diffraction efficiency of SRG 74 in diffractive grating structure 88 across gradient lateral edges 94 (in the direction of arrows 110), preventing a sharp boundary between diffractive grating structure 88 and the surrounding portions of substrate 89. The manufacturing equipment used to form diffractive grating structure 88 of FIG. 9 mayinclude a mask (not shown for the sake of clarity) that passes etching elements 140 in a way that causes the etching elements 140 to form the SRG(s) 74 of diffractive grating structure 88 in substrate 89 with the desired varying duty cycle within gradient lateral edges 94.

The examples of FIGS. 7-9 are merely illustrative. Any desired combination of varying coating thickness (FIG. 7), varying grating depth (FIG. 8), and varying duty cycle (FIG. 9) may be used to configure the SRG(s) 74 in diffractive grating structure 88 to exhibit decreasing strength (diffraction efficiency) in the direction of arrows 110 across gradient lateral edges 94. For example, the SRG(s) 74 in diffractive grating structure 88 may have a variable duty cycle, a decreasing trough depth, and/or a coating 124 with decreasing thickness in the direction of arrows 110 across gradient lateral edges 94. More generally, any desired combination of modulation of the amplitude of the SRG(s) (e.g., the height of ridges 78 of FIGS. 3A-3C and/or the depth of troughs 80 of FIGS. 3A-3C), the phase of the SRG(s), the duty cycle of the SRG(s), the blaze angle of the SRG(s), the thickness of a coating layered over the SRG(s), and/or any other desired properties of the SRG(s) may be used to form gradient lateral edges 94.

Gradient lateral edges 94 may serve to prevent the sharp boundary that otherwise causes diffractive grating structure 88 and the corresponding optical coupler to become undesirably visible, noticeable, and/or distracting to the user of system 10 and/or to other persons facing system 10 while system 10 is being worn by the user (e.g., may mitigate the formation of a rainbow-colored region or cosmetic artifact on waveguide 32) and/or may minimize perturbation of replicated pupils, thereby improving modulation transfer function (MTF) and mitigating cosmetic image artifacts such as smear and double images.

The foregoing is merely illustrative and various modifications can be made to the described embodiments. The foregoing embodiments may be implemented individually or in any combination.

What is claimed is:

1. An electronic device comprising:
a waveguide;
a substrate on the waveguide; and
a surface relief grating (SRG) in the substrate, wherein the SRG has a gradient lateral edge.

2. The electronic device of claim 1, further comprising:
a coating on the SRG, wherein the coating has a decreasing thickness across the gradient lateral edge.

3. The electronic device of claim 2, wherein the SRG has grooves with depths that decrease across the gradient lateral edge.

4. The electronic device of claim 3, wherein the SRG has a varying duty cycle across the gradient lateral edge.

5. The electronic device of claim 2, wherein the SRG has a varying duty cycle across the gradient lateral edge.

6. The electronic device of claim 1, wherein the SRG has a varying duty cycle across the gradient lateral edge.

7. The electronic device of claim 6, wherein the SRG has grooves with depths that decrease across the gradient lateral edge.

8. The electronic device of claim 1, wherein the SRG has grooves with depths that decrease across the gradient lateral edge.

9. The electronic device of claim 1, further comprising:
an input coupler that comprises the SRG and that is configured to couple light into the waveguide;
an output coupler configured to couple the light out of the waveguide; and
a cross-coupler configured to redirect the light from the input coupler towards the output coupler.

10. The electronic device of claim 1, further comprising:
an input coupler configured to couple light into the waveguide;
an output coupler that comprises the SRG and that is configured to couple the light out of the waveguide; and
a cross-coupler configured to redirect the light from the input coupler towards the output coupler.

11. The electronic device of claim 1, further comprising:
an input coupler configured to couple light into the waveguide;
an output coupler that is configured to couple the light out of the waveguide; and
a cross-coupler that comprises the SRG and that is configured to redirect the light from the input coupler towards the output coupler.

12. The electronic device of claim 1, further comprising:
an input coupler configured to couple light into the waveguide; and
an interleaved coupler that comprises the SRG and an additional SRG overlapping the SRG, wherein the interleaved coupler is configured to expand the light and to couple the light out of the waveguide, the SRG has a first grating vector, and the additional SRG has a second grating vector non-parallel to the first grating vector.

13. An electronic device comprising:
a waveguide;
an input coupler configured to couple light into the waveguide;
a substrate on the waveguide; and
a surface relief grating (SRG) in the substrate and configured to redirect the light coupled into the waveguide by the input coupler, wherein the SRG includes
a central region, and
a peripheral region that laterally separates the central region from a non-diffractive portion of the substrate, the peripheral region having a diffraction efficiency that decreases from the central region to the non-diffractive portion of the substrate.

14. The electronic device of claim 13, wherein the SRG has a peak diffraction efficiency within the central region and the peripheral region laterally surrounds the central region.

15. The electronic device of claim 14, wherein the SRG has grooves and a depth of the grooves decreases, in the peripheral region, from the central region to the non-diffractive portion of the substrate.

16. The electronic device of claim 14, wherein the SRG has a duty cycle that varies, in the peripheral region, from the central region to the non-diffractive portion of the substrate.

17. The electronic device of claim 14, further comprising:
a coating on the SRG, wherein the substrate has a first refractive index, the coating has a second refractive index that is different from the first refractive index, and the coating has a thickness that decreases, in the peripheral region, from the central region to the non-diffractive portion of the substrate.

18. The electronic device of claim 14, wherein the SRG has a non-perpendicular blaze angle that varies, in the peripheral region, from the central region to the non-diffractive portion of the substrate.

19. An electronic device comprising:
a waveguide;
a substrate on the waveguide;
a first surface relief grating (SRG) on the substrate; and
a second SRG on the substrate, wherein
the second SRG overlaps the first SRG within a first region and a second region of the substrate,
the first SRG is oriented non-parallel with respect to the second SRG,
the first SRG and the second SRG have a first diffraction efficiency within a first region of the substrate,
the substrate has a second diffraction efficiency within a second region of the substrate,
the first SRG and the second SRG have a gradient diffraction efficiency within a third region of the substrate,
the third region of the substrate laterally surrounds the first region of the substrate and laterally separates the first region of the substrate from the second region of the substrate, and
the gradient diffraction efficiency decreases from the first diffraction efficiency at the first region to the second diffraction efficiency at the second region.

20. The electronic device of claim 19, wherein the second diffraction efficiency is zero.
